(19) United States
(12) Patent Application Publication
(10) Pub. No.: US 2021/0319504 A1
(43) Pub. Date: Oct. 14, 2021

(54) SYSTEM AND METHOD FOR DETERMINING BANKING RESERVES

(71) Applicant: Scott A. SMITH, Boulder, CO (US)

(72) Inventor: Scott A. SMITH, Boulder, CO (US)

(21) Appl. No.: 16/845,960

(22) Filed: Apr. 10, 2020

(51) Int. Cl. G06Q 40/02; G06Q 40/06; G06Q 10/04; G06Q 10/06

(52) U.S. Cl. CPC G06Q 40/02; G06Q 40/06; G06Q 50/26; G06Q 10/06313; G06Q 10/0637; G06Q 10/04

(57) ABSTRACT

A system, apparatus or method is provided to collect economic data from one or more financial systems. Identification information is retrieved for a central bank and a plurality of service agent banks. Using the retrieved information, the central bank and the plurality of service agent banks are designated as part of a banking construct. An optimization scenario is simulated based on the collected economic data, the banking construct, and one or more business rules. The simulated optimization scenario is output, and banking reserves for the banking construct are determined based on the simulated optimization scenario.

### BACKGROUND

Conventional banking systems are rooted in a time when money was gold. In the past, a primary purpose of banks was to ensure there was sufficient gold available to support transactions in the economy. Thus, banks had to aggregate gold, and because that was expensive, this led to there being a “cost of funds.” In other words, banks had to pay for deposits; so, to earn profits the banks would loan the money they received at interest. However, there exists a serious logistical problem with interest. By way of example, since an interest-bearing account grows in perpetuity, it suggests that an interest bearing account should be able to grow to the point that it would eventually contain all monies in the economy; this cannot actually happen because every consumers' accounts earn interest simultaneously. Thus, the money supply must grow over time to make up for this problem, which is why the value of money declines with time when interest is allowed.

### SOME EXAMPLE EMBODIMENTS

Therefore, there is a need for an approach that mitigates the detrimental effects of interest by determining banking reserves for allocation into appropriate sectors of the economy.

According to one embodiment, a method, executed on a computerized platform for determining volume of banking reserves, comprises collecting economic data from one or more financial systems, wherein the economic data relates to gross domestic product information, gross national product information, global productive capacity information, inflationary information, labor information, labor effectiveness information, or a combination thereof. The method also comprises retrieving identification information for a central bank and a plurality of service agent banks; designating, using the retrieved information, the central bank and the plurality of service agent banks as part of a banking construct; simulating an optimization scenario based on the collected economic data, the banking construct, and one or more business rules; outputting the simulated optimization scenario; and determining banking reserves for the banking construct based on the simulated optimization scenario.

According to another embodiment, an apparatus comprises at least one processor; and at least one memory including computer program code for one or more programs, the at least one memory and the computer program code configured to, with the at least one processor, cause the apparatus to perform at least the following: collect economic data from one or more financial systems; retrieve identification information for a central bank and a plurality of service agent banks; simulate an optimization scenario based on the collected economic data, the banking construct, and one or more business rules; output the simulated optimization scenario; and determine banking reserves for the banking construct based on the simulated optimization scenario.

According to another embodiment, a system comprises one or more servers configured to collect economic data from one or more financial systems, wherein the one or more servers is further configured to collect economic data from one or more financial systems; retrieve identification information for a central bank and a plurality of service agent banks; designate, using the retrieved information, the central bank and the plurality of service agent banks as part of a banking construct; simulate an optimization scenario based on the collected economic data, the banking construct, and one or more business rules; output the simulated optimization scenario; and determine banking reserves for the banking construct based on the simulated optimization scenario.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side (or backend system) or on the mobile device side or in any shared way between the service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of an economic system optimization platform capable of determining volume of banking reserves, according to one embodiment;

FIG. 2 is a diagram of the components of the economic system optimization platform of FIG. 1, according to one embodiment;

FIGS. 3A and 3B is a flowchart of a process for determining volume of banking reserves, according to one embodiment;

FIG. 4 is a diagram of a user interface utilized in the processes of FIGS. 3A and 3B, according to various embodiments;

FIG. 5 is a diagram of hardware that can be used to implement various example embodiments;

FIG. 6 is a diagram of a chip set that can be used to implement various example embodiments; and

FIG. 7 is a diagram of a mobile terminal (e.g., handset) that can be used to implement various example embodiments.

### DESCRIPTION OF SOME EMBODIMENTS

Examples of a method, apparatus, and computer program for determining banking reserves for allocation into appropriate sectors of the economy are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

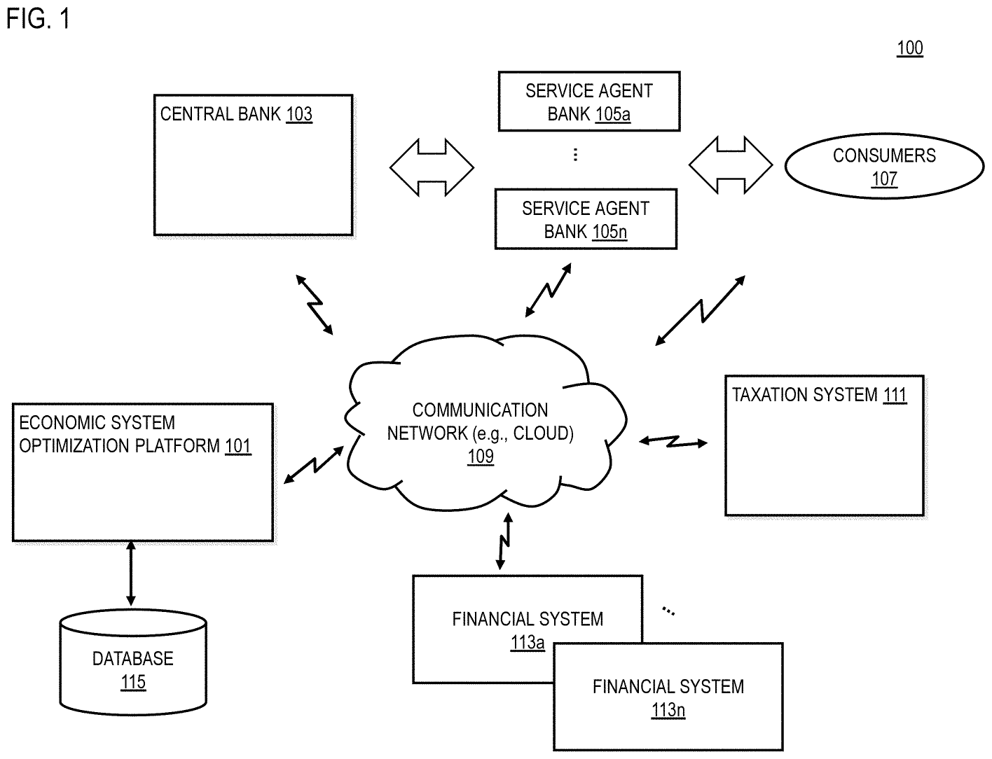

FIG. 1 is a diagram of an economic system optimization platform capable of determining volume of banking reserves, according to one embodiment. Although the uses cases described herein relate to Gross Domestic Product (GDP) and Gross National Product (GNP) as well as the economy of the United States of America, it is contemplated that the processes and mechanisms of platform can be deployed to other economic indicators, banking systems, and economies around the world.

By way of example, in the United States (US), the financial sector has grown to the point that it garners a significant percentage (e.g., almost 40%) of the country's profits. This is detrimental for the US economy. The role of the monetary economy is to facilitate growth in the material economy, not deplete it. Any excess that is paid into the financial sector saps production and increases the cost of living. Excess in the banking industry acts as friction, effectively destroying the production of the material economy. Rather than impeding growth, banks should be incentivized to stoke the production engine in the material economy. That is, banks need to provide financial services, but require them to create as little friction as possible.

To address this problem, a system 100 of FIG. 1 includes an economic system optimization platform 101 that introduces the capability to reduce the banking friction (e.g., interest) by determining banking reserves for allocation into appropriate sectors of the economy (e.g., material economy).

As shown in FIG. 1, the system 100 also comprises a central banking system or central bank 103, e.g., the Federal Reserve, that interfaces with one or more service agent banks 105a-105n, which act as intermediaries to consumers 107. As used herein, the term “service agent bank” and “service agent” are synonymous. These entities 103, 105, and 107 may communicate via a communication network 109, which can provide a cloud service to facilitate the exchange of information. Additionally, a taxation system 111, which may be operated by the Internal Revenue Service (IRS), is accessible by the platform 101 for information gathering and providing directives. The platform 101, as will be further detailed below, can perform a simulation to optimize economic parameters associated with the banking construct formed by the central banking system 103 and the service agent banks 105a-105n. Moreover, the platform 101 can access any number of financial systems 113a-113n to collect the needed economic data to perform the simulation. These financial systems 113a-113n may be any source, governmental or non-governmental. According to one embodiment, the collected information and simulation results may be stored in a database 115, which may be under control of the operator of the platform 101.

By way of illustration, the system 100 is described with respect to the US economy and banking system; however, it is contemplated that the system 100 can be utilized for any region in the world. A financial operating system involves an intricate web of financial microservices, similar to how cloud-based computing solutions utilize an array of cloud microservices. Examples of these financial microservices include taxation (e.g., income, payroll, capital gain, sales, and excise taxes, etc.), government sponsored benefits (e.g., education, welfare, Medicare, Medicaid, Social Security, pensions, unemployment, etc.), securities markets (e.g., public stock exchanges, mercantile exchanges, private equity, venture equity, mortgage backed securities, derivative markets, Forex exchanges and crypto exchanges, etc.), and banking (e.g., the Federal Reserve), private banks, credit unions, payment systems, etc.. In a sense, each of these financial microservices utilize a combination of both open source and proprietary financial technologies. In recognition of this system, the platform 101 advantageously, within the banking and taxation microservice system, optimizes the economy in terms of 1) providing greater financial stability for both the nation's citizens and its businesses, 2) stimulating economic growth, 3) improving liquidity within the financial system, and 4) maximizing the financial well-being of these citizens.

Rather than impeding growth, it is desirable for banks, as well as the tax and benefits system, to stimulate the production engine in a country's material economy. That is, banks should provide financial services, but also create as much benefit as possible with as little friction as possible.

As discussed, at present banks still aggregate money, just as they have for centuries; as such, they incur “a cost of funds.” It is recognized that this need not be the case; in other words, banks need not aggregate money, because (as in the case of the United States) the authority to create money has been given to a central bank—i.e., the Federal Reserve.

Thus, as shown in FIG. 1, relationships with such a central bank 103 can be structured in form of “service agents.” These service agent banks 105a-105n can originate and underwrite loans, service loans, foreclose in the event of a default, manage lines of credit, manage deposits, invest in private equities, invest in start-up equities, and even invest in foreign projects, etc. The service agent banks 105a-105n can perform all the functions of traditional banks as well as other financial institutions; however, such service agent banks 105a-105n will be acting as intermediaries of the central bank 103 (which can be the Federal Reserve) for the consumers 107.

Under this system 100, the money/deposits of the consumers 107 could actually be held by the central bank 103 (e.g., Federal Reserve), with the service agent bank 105a-105n providing the interface for deposits and withdrawals. Under such arrangement, advantageously the possibility of bank failures and the loss of the consumers' deposits are eliminated. In other words, this eliminates the need for a service agent to have deposits in order to participate in banking activities, and thus eliminating the risk of consumers lodging their money with a bank. Moreover, because the service agents 105a-105n would be lending the Federal Reserve's money instead of their depositors' money, a service agent bank (e.g., a small community bank) could have greater lending power than even a big national bank of today, thereby stimulating more competition.

The system 100 enables the service agent banks 105a-105n, as agents to the central bank 103 (e.g., Federal Reserve) to provide both domestic and international finance on an unprecedented level compared to today's banking institutions—this would strengthen a country's global influence. Through such intermediaries (e.g., service agent banks 105a-105n) of the Federal Reserve, the capital available for investment would potentially be unlimited; and none of the funds would come from taxpayers -- as it does today with the World Bank and the International Monetary Fund (IMF). In the system 100, the central bank 103 has the ability to generate, at no cost, whatever reserves are necessary to support any projects, whether domestic or foreign. The returns on the investments that such service agent banks 105a-105n can make, for example, in foreign countries would be highly beneficial to the US economy, with the potential to even pass a portion of the profits on to citizens in the form of Federal Reserve dividends.

Advantageously, the economics system optimization platform 101 can output a scenario for the banking construct defined by the central banking system 103 and the service agent banks 105a-105n to reduce the cost of funds by eliminating the need for interest in many instances. The problem with interest-bearing accounts is that they have the potential to grow in perpetuity, as discussed earlier. As such, the money supply must grow over time to make up for this phenomenon, which may be why the value of money declines with time when interest is utilized with a monetary system. With interest eliminated, the following example illustrates the possible savings:
The monthly payment on a $400,000 mortgage charging 5% interest amortized over 30 years could be reduced from $2,147 to $1,111, saving $372,960.
The monthly payment on a $100,000 student loan charging 6.8% percent interest amortized over 20 years could be reduced from $763 to $417, saving $83,040.

By reducing the cost of credit in this way, the system 100 would not only help citizens on a personal level, but the economy would greatly benefit. The money that citizens would save by not paying interest would be put back into the economy. For instance, interest-free mortgages would cut the monthly cost of home ownership nearly in half. By contrast, conventional banks qualify a borrower for a mortgage, permitting, e.g., up to ⅓ of the borrower's income to be spent on the mortgage. The system 100 could shrink the cost of housing from one third of the income to just one sixth of the income.

The detrimental effects of interest can be seen during the recessionary period involving the subprime mortgage crisis (which peaked in 2008). Not only did millions of people lose their homes, the US government spent billions on bailing out the banks. The US government would have spent less and avoided many foreclosures if they had been able to roll back interest rates. The root cause of the recession was inefficiencies within the financial sector, which this system 100 addresses. It is recognized that there was nothing wrong with the material economy, but that the financial sector was costing too much.

Additionally, the system 100 can improve efficiency of the taxation system 107. Within the US, the country currently gathers the money paid in taxes, sending it through the IRS to the US Treasury. Money is borrowed through the issuance of Treasury bonds to make up any shortfall in the money collected through taxes compared to federal spending. As noted above, under this system 100, the central bank 103 (e.g., Federal Reserve) has the ability to generate, at no cost, whatever reserves are necessary to support projects, whether domestic or foreign; that includes funding federal spending. Traditionally, the reason that all of the money necessary for federal spending is not generated through the Federal Reserve is because rapidly expanding the monetary supply will result in runaway inflation. Taxes, then, can be seen as a means of pulling money out of the money supply in order to make room for federal spending. Federal spending injects money into the economy, while taxes pull money out of the economy.

Under the approach employed by the system 100, the central bank 103 can generate reserves to pay for federal spending, while the payment system (e.g., taxation system 107) could be used to delete all money paid in taxes from the money supply. Deleting money from the money supply can be readily accomplish by the taxation system 107 through the direction of the economic system optimization platform 101. Instead of crediting payroll or withholding taxes to the IRS, the system 107 could be instructed to simply not credit the money to any account. In this manner money would be deleted from the monetary system as money is also being generated by the central bank 103.

Accordingly, the system 100, in various embodiments, thus, provides the following advantages: 1) reduce the overhead of aggregating money from hundreds of millions of accounts and moving it through the system to the US Treasury (or equivalent department in other countries); and 2) eliminate the need to issue Treasury bonds to make up for any shortfall in revenues. Thus system 100 eliminates the problem of the growing national debt and the mounting cost of servicing that debt. Generating reserves to pay for the shortfall instead of borrowing would be less inflationary than the current system, as issuing Treasury bonds to cover the shortfall requires the payment of interest over time, which, as discussed, requires the continuous expansion of the money supply.

Although not shown, various user equipment (UE) that may include or be associated with applications to interact with the customer. In one embodiment, the UE has connectivity to the economic system optimization platform 101 via the communication network 109. In one embodiment, the economic system optimization platform 101 performs one or more functions associated with determining volume of banking reserves for the banking construct. By way of example, the UE is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, a smartphone, a smartwatch, smart eyewear, or any combination thereof, including the accessories and peripherals of these devices, or any combination thereof. It is also contemplated that the UE can support any type of interface to the user (such as “wearable” circuitry, etc.).

The communication network 109 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including 5G (5^{th} Generation), 4G, 3G, 2G, Long Term Evolution (LTE), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

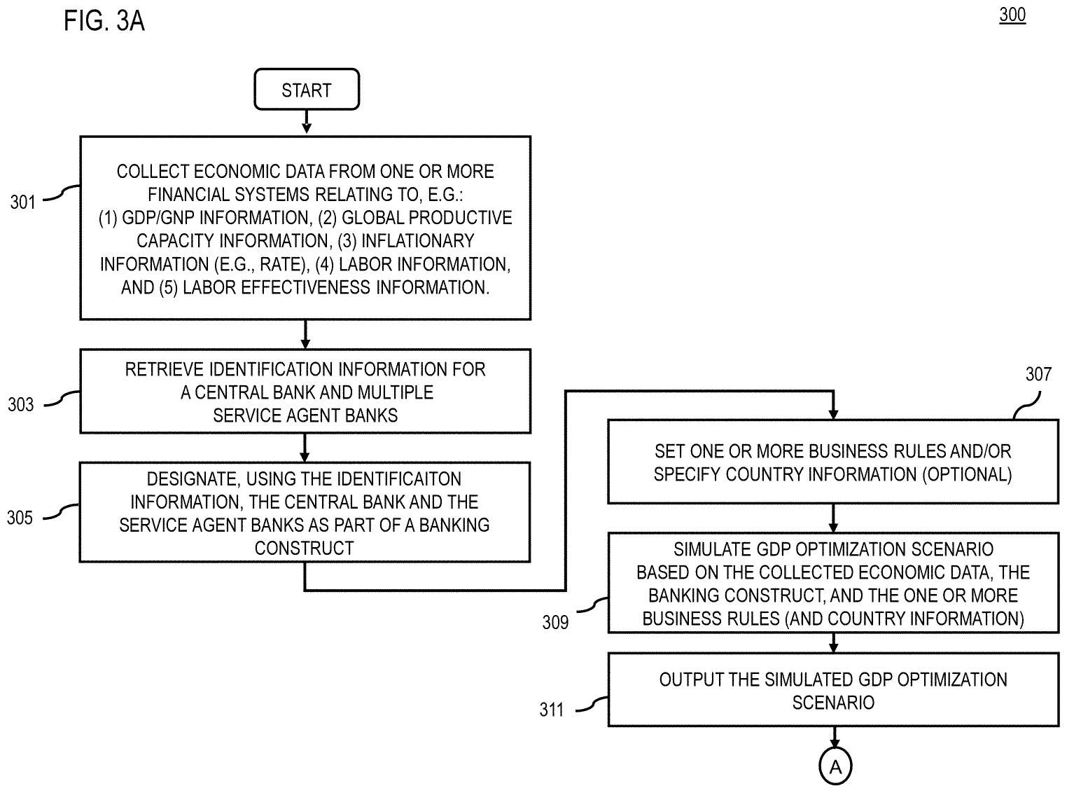

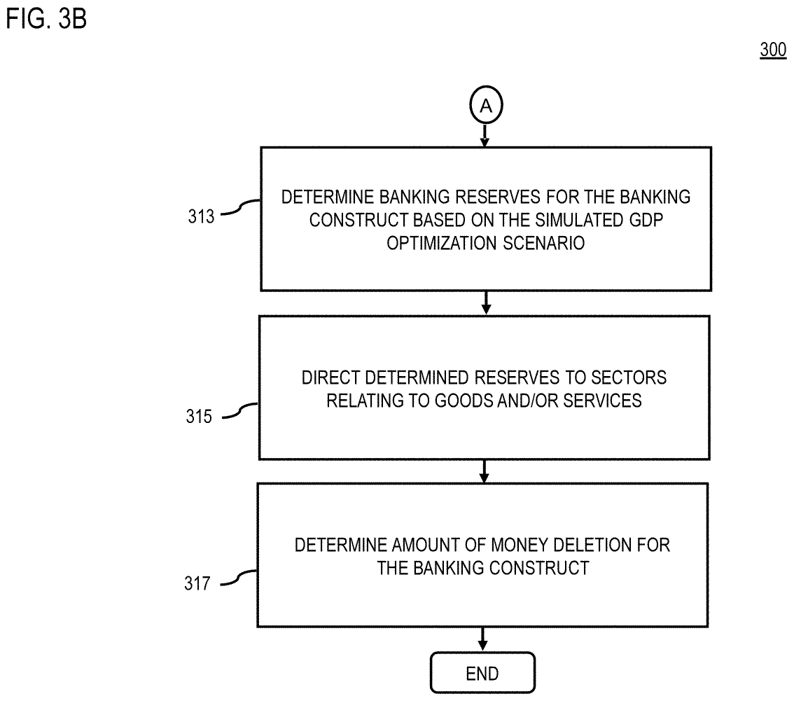

In one embodiment, the platform 101 may be a platform with multiple interconnected components. The platform 101 may include multiple servers, intelligent networking devices, computing devices, components and corresponding software for providing one or more steps of the process of FIGS. 3A and 3B. Also, certain functionalities of the platform 101 may reside within the UE (e.g., as part of an application).

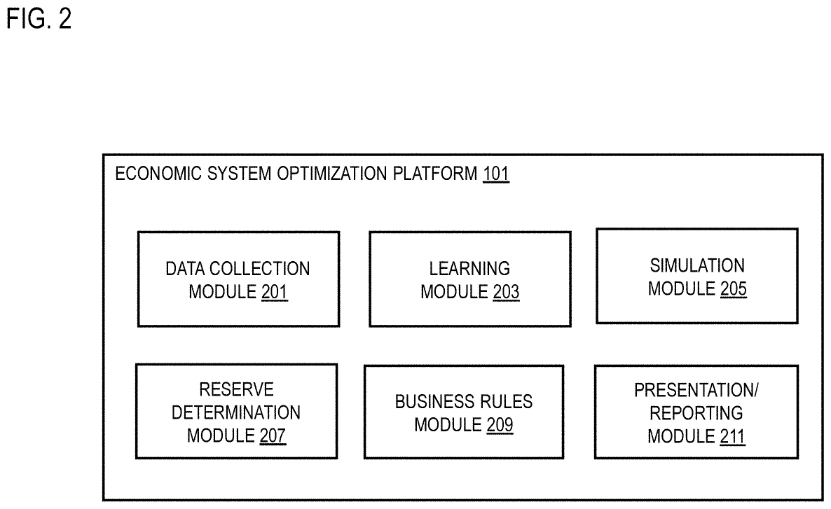

FIG. 2 is a diagram of the components of the economic system optimization platform of FIG. 1, according to one embodiment. By way of example, the platform 101 includes one or more components for providing determination of banking reserves according to an optimized scenario for a country's economy. It is contemplated that the functions of these components may be combined in one or more components or performed by other components of equivalent functionality. In this embodiment, the platform 101 includes a data collection module 201, a learning module 203, a simulation module 205, a reserve determination module 207, a business rules module 209, and a presentation/reporting module 211.

The platform 101 in essence provides the central bank 103 (e.g., the Federal Reserve) a set of tools, as provided through the various modules 201-211 in conjunction with the central bank 103, the service agent banks 105a-105n, and the taxation system 107, for managing the economy. These tools are an important improvement over the two tools that a central bank, like the Federal Reserve, has historically used to manage the economy. In the 1980s, the Federal Reserve first began to proactively manage economic activity by raising and lower interest rates. An increase in interest rates was found to be an effective means to slow economic activity in order to stave off inflation. Raising interest rates has its negative side effects, however. Inflation is an unwanted increase in consumer prices. A key underlying factor in the price of a consumer product or service are the costs within the supply chain behind the production, transportation, and retailing of the product. All of the components with the supply chain are influenced by the cost of finance. Thus, when the Federal Reserve raises rates, the cost of goods and services increases, which slows consumer activity. This poses a grave problem. The Federal Reserve increases costs in order to slow inflation.

The Federal Reserve's second tool for managing the economy is Quantitative Easing (QE). The advent of QE began in earnest as a means of pulling the economy out of the 2008 recession. Quantitative Easing entails the generation of reserves by the Federal Reserve, which the Federal Reserve then uses to buy and hold securities. An initial fear was that the use of QE would be inflationary. However, QE did not significantly impact consumer prices simply because the cash being injected into the economy went into the coffers of institutional investors, not into the pockets of the consumer. In other words, the entity selling a block of Treasury bonds to the Federal Reserve did not use the money that it had received from the sale of the bonds to buy services or products, like bread, it used the money to buy another security. This resulted in an increase in the price of assets, which could be viewed as a form of inflation amongst securities, rather than amongst consumer products. The limitation with QE is that its impact misses the most important sector within the economy—the production of goods and services for the consumer.

The platform 101 directs the generation of reserves within the central bank 103 (e.g., Federal Reserve) to sector of the economy responsible for producing goods and/or services. Utilizing service agents 105a-105n to lend and invest central bank-generated reserves into, for example, housing, commercial real estate, private equity, start-ups, infrastructure, and foreign development stimulates real economic growth, not just an increase in the price of assets. Likewise, adjusting the rate at which money is pulled from the economy, especially with a payments tax, compared to the amount of reserves generated by the Federal Reserve for the purpose of government spending, is a powerful tool for managing economic activity.

In one embodiment, the data collection module 201 can connect to various systems, such as the financial systems 113a-113n to retrieve economic data of a particular region or country (e.g., US). For example, the economic data includes gross domestic product information, gross national product information, global productive capacity information, inflationary information, labor information, labor effectiveness information.

The platform 101 comprises a learning module 203 that can utilize artificial intelligence (AI), such as deep learning and machine learning, to process the economic data from the data collection module 201 to categorize and analyze information for input to the simulation module 205. The simulation module 205 provides the capability to execute various scenarios to optimize for achieving certain economic objectives (as specified through one or more business rules), the collected economic data, and the banking arrangement or construct (which defines the roles and responsibilities between a central bank 103 and one or more service agent banks 105a-105n).

The business rules module 209 permits the creation or configuration of various business rules, which correspond to various business objectives for a particular economic system. Upon application of these business rules, the simulated scenario output from the simulation module 205 can be utilized to determine the volume of banking reserves by the reserve determination module 207.

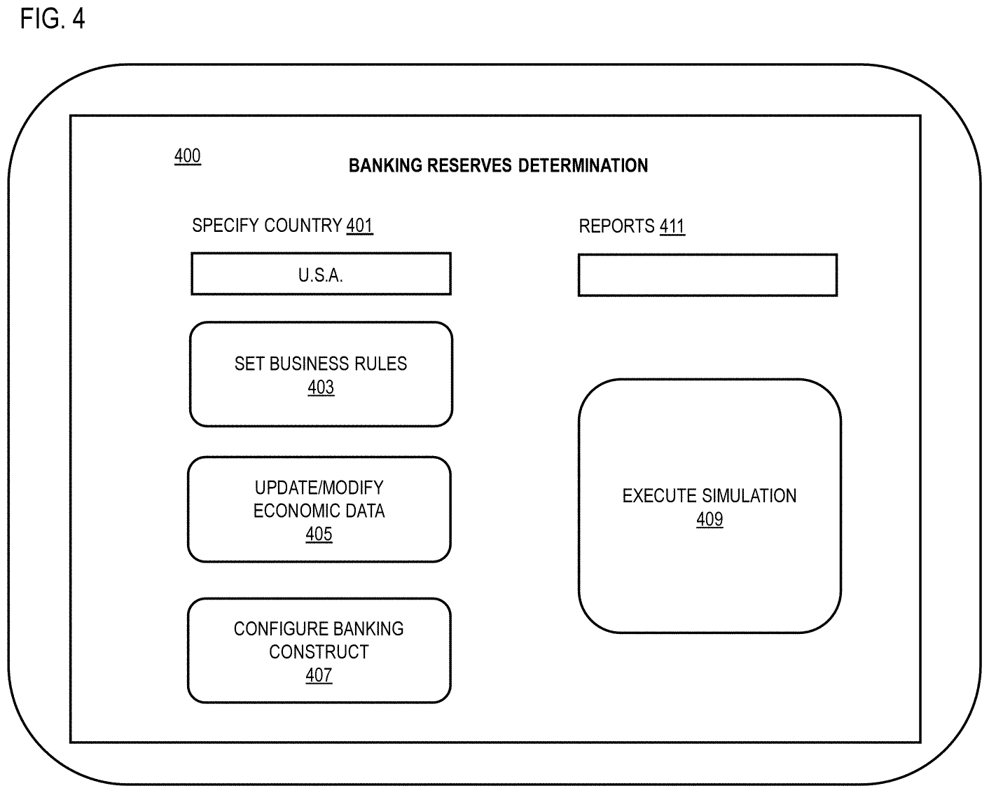

Further, the economic system optimization platform 101 includes, according to one embodiment, a presentation/report module 211 to output the results of the reserve determination module 207 and/or the simulation module 205 via a graphical user interface (as detailed in FIG. 4).

The above presented modules and components of the platform 101 can be implemented in hardware, firmware, software, or a combination thereof. Though depicted as a separate entity in FIG. 1, it is contemplated that the platform 101 may be implemented for direct operation by respective UE. As such, the platform 101 may generate direct signal inputs by way of the operating system of the UE for interacting with the applications 103. In another embodiment, one or more of the modules 201-211 may be implemented for operation by respective UEs, the platform 101, or combination thereof.

FIGS. 3A and 3B is a flowchart of a process for determining volume of banking reserves, according to one embodiment. Per step 301, the platform 101 collects collect economic data from one or more financial systems 113a-113n. Such economic data, for example, relates to gross domestic product information, gross national product information, global productive capacity information, inflationary information, labor information, or labor effectiveness information. In step 303, the platform 101 retrieve identification information for a central bank and one or more of service agent banks. According to one embodiment, the central bank can be the Federal Reserve, and the intermediary banks that act as service agents can be any commercial bank and/or credit union. Using the retrieved information, the central bank and the service agent banks are designated as part of a banking construct, as in step 305.

In step 307, the platform 101 may, optionally, provide for setting or configuring of one or more business rules. Moreover, the platform 101 permits selection of a country or region to execute the simulation for. An optimization scenario, per step 309, is simulated based on the collected economic data, the banking construct, and one or more business rules. In one embodiment, using, the GUI of FIG. 4, the one or more business rules are set or configured. The one or more business rules, for instance, can specify thresholds on consumer spending, business investment, government spending, net export, money supply, or a combination thereof. According to one embodiment, the one or more business rules can be set to permit a service agent bank to participate in banking activities without a deposit requirement. The simulated optimization scenario is output (as in step 311), and banking reserves for the banking construct are determined based on the simulated optimization scenario.

According to one embodiment, the simulated optimization scenario specifies interest rates that produce less drag on the economy, and reduce unnecessary growth in the money supply, while optimizing consumer spending; this can be implemented through the application of business rules. Also, another simulated optimization scenario can involve determining certain economic parameters and conditions, whereby the distribution (or direction) of the determined reserves can enhance a country's influence vis-à-vis the rest of the world, and can ensure the country benefits from the global world growth. That is, investment of foreign economies can be part of the country's strategy for economic and/or political influence.

As shown in FIG. 3B, banking reserves are determined by the platform 101, per step 313, for the banking construct based on the simulated optimization scenario. According to one embodiment, the scenario relates to GDP; it is contemplated that any economic indicator can be utilized in this simulation, such as GNP. In step 315, the platform 101 directs the determined reserves to one or more economic sectors relating to goods and/or services. Traditionally, banks allocate certain reserves to acquire securities versus actively involving the material economy. Another aspect of the optimization scenario is the determination of the amount of money deletion for the banking construct (per step 317); the platform 101 then directs the taxation system 107 appropriately based on this determination.

When taxes are understood as being a means of deleting money, according to on embodiment, from the money supply, instead of being understood as being a means of generating revenue for the government, then it is also possible to engineer a much more efficient system of taxation. For example, a simple deletion of a tiny fraction of every payment flowing through the national payment system could be used to eliminate the need for income, payroll, sales and property taxes, which would greatly reduce the personal taxes that citizens pay under the current taxation scheme.

According to data published by the Federal Reserve in the Red Book (an annual publication of the Bank for International Settlements) over $5,000 trillion flows through the US payment system annually. That is a much greater number than the approximate $16 trillion earned by US citizens each year, which is the tax base for income, payroll, sales, and property taxes. A deletion, for instance, of just 0.1% from each payment made in the US payment system each year would not only eliminate the need to charge any income, payroll, sales or property taxes, it would also eliminate the deficit. Notably, a deletion of just 0.2% from each payment made in the US payment system each year would be sufficient to not only balance the existing federal budget, but to also pay $24,000 per year in basic income to every US citizen, and to provide free basic healthcare and higher education to every US citizen.

The above process can be executed by a user interacting with the economic system optimization platform 101 using a graphical user interface (GUI), as shown in FIG. 4, provided by any computerized device, such as the UE described previously.

FIG. 4 is a diagram of a user interface utilized in the processes of FIGS. 3A and 3B, according to various embodiments. In this example, the GUI 400 provides for an area 401 for selecting a region or country for the determination of the reserves for that region's banking system. This selection can be in form of a dropdown menu, for instance. Additionally, section 403 (which may be a button) provides for input by a user of one or more business rules for the simulation as discussed previously with respect to FIGS. 3A and 3B. The GUI 400 also provides for a section 405 to update and/or modify economic data that is to be utilized in the simulation. Section 407 permits specification of the banking construct. That is, the user can indicate a particular central bank as well as the service agent banks. Once all the appropriate information is collected and specified, the simulation can be executed by activating or triggering section 409. The results of the simulation can be in form of reports; various reports can be specified via section 411.

The processes described herein for determining banking reserves for allocation into appropriate sectors of the economy may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

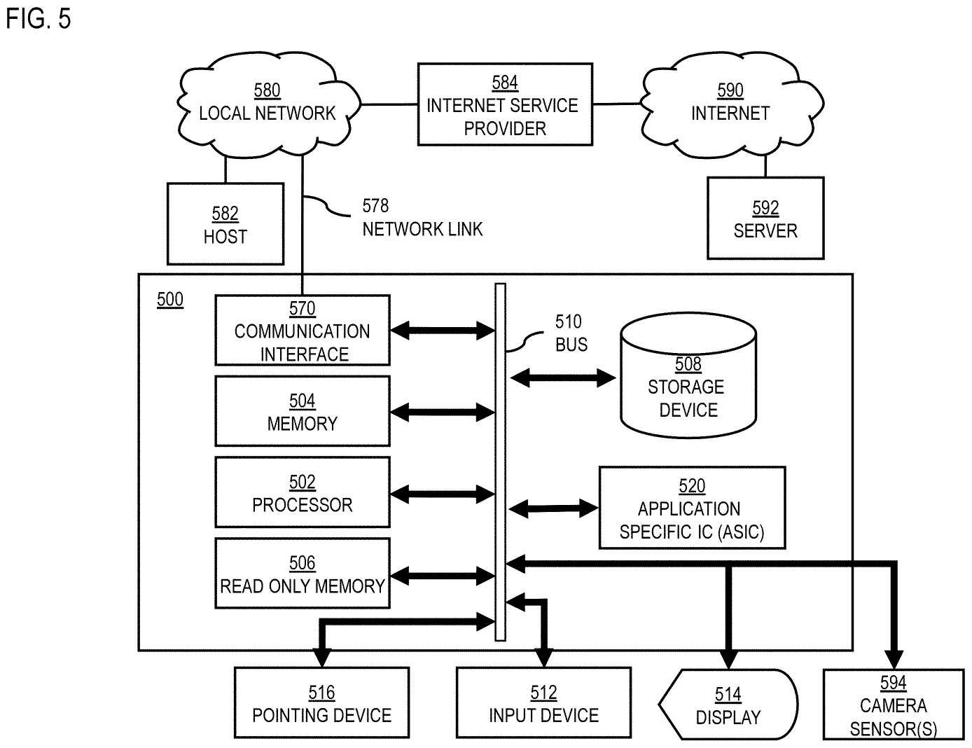

FIG. 5 illustrates a computer system 500 upon which various embodiments of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to provide one or more steps of the process of FIGS. 3A and 3B and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of the process of FIGS. 3A and 3B.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to determining banking reserves for allocation into appropriate sectors of the economy. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 500 also includes a memory 504 coupled to bus 510. The memory 504, such as a random access memory (RAM) or any other dynamic storage device, stores information including processor instructions for determining banking reserves for allocation into appropriate sectors of the economy. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for determining banking reserves for allocation into appropriate sectors of the economy is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a vacuum fluorescent display (VFD), a liquid crystal display (LCD), a light-emitting diode (LED), an organic light-emitting diode (OLED), a quantum dot display, a virtual reality (VR) headset, a plasma screen, a cathode ray tube (CRT), or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514, and one or more camera sensors 594 for capturing, recording and causing to store one or more still and/or moving images (e.g., videos, movies, etc.) which also may comprise audio recordings. In some embodiments, for example, in embodiments in which the computer system 500 performs all functions automatically without human input, one or more of external input device 512, a display device 514 and pointing device 516 may be omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners, and external disks. In general, the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 57.

The term “computer-readable medium” as used herein refers to any medium that participates in providing information to processor 502, including instructions for execution. Such a medium may take many forms, including, but not limited to a computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

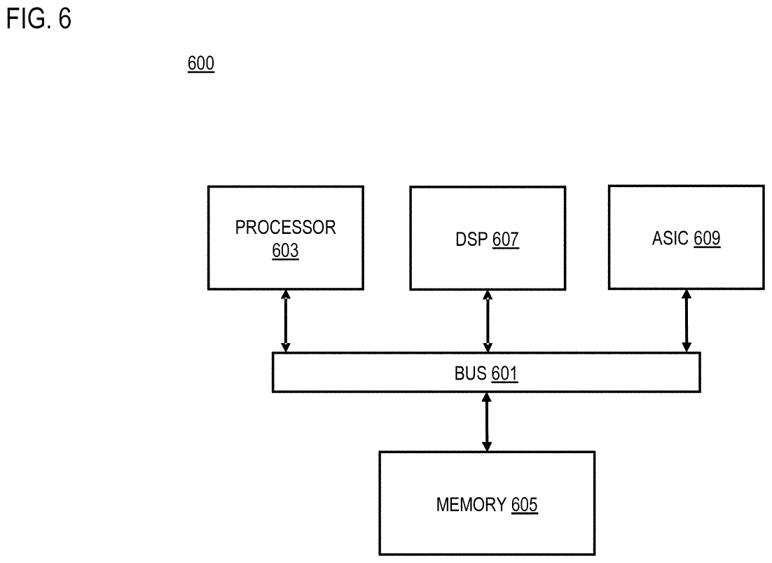

FIG. 6 illustrates a chip set or chip 600 upon which various embodiments of the invention may be implemented. Chip set 600 is programmed to provide one or more steps of the processes of FIGS. 3A and 3B as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of determining banking reserves for allocation into appropriate sectors of the economy.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively, or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to provide the process of FIGS. 3A and 3B. The memory 605 also stores the data associated with or generated by the execution of the inventive steps.

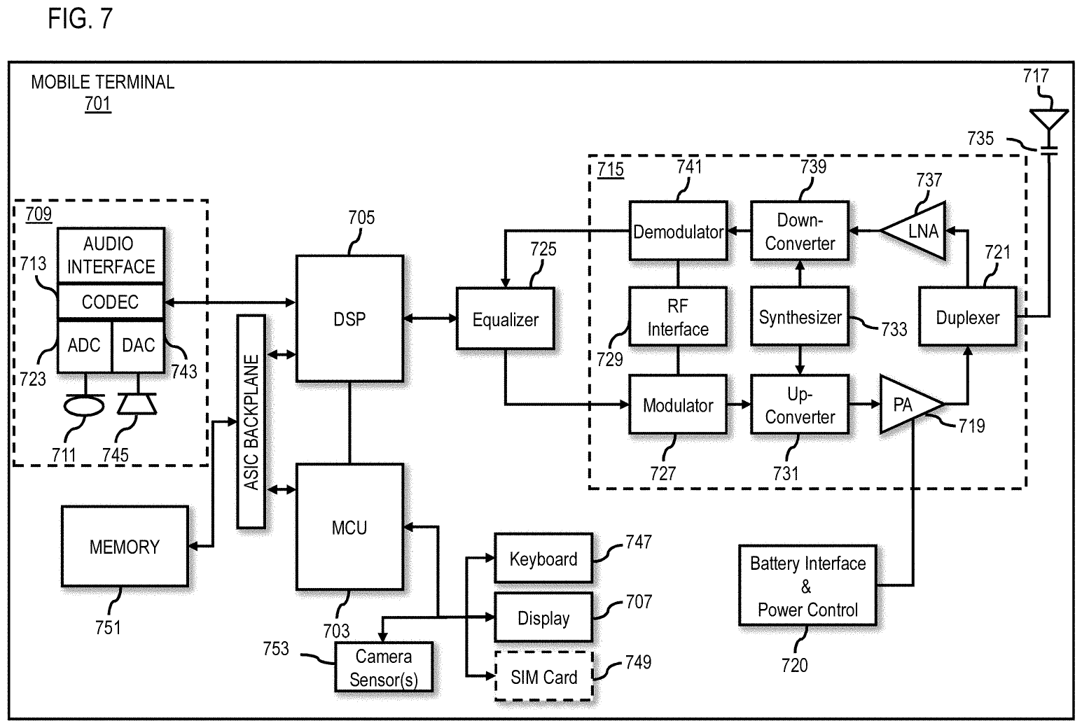

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of the process of FIGS. 3A and 3B. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of determining banking reserves for allocation into appropriate sectors of the economy. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies the power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with an RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a landline connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to provide one or more steps of the process of FIGS. 3A and 3B. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

Further, one or more camera sensors 753 may be incorporated onto the mobile station 701 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A system comprising:
one or more servers configured to collect economic data from one or more financial systems, wherein the one or more servers is further configured to,
collect economic data from one or more financial systems;
retrieve identification information for a central bank and a plurality of service agent banks;
designate, using the retrieved information, the central bank and the plurality of service agent banks as part of a banking construct;
simulate an optimization scenario based on the collected economic data, the banking construct, and one or more business rules;
output the simulated optimization scenario; and
determine banking reserves for the banking construct based on the simulated optimization scenario.

2. A system of claim 1, wherein the one or more servers are further configured to:
direct the determined reserves to one or more economic sectors relating to goods and/or services,
wherein the simulated optimization scenario specifies distribution of a portion of the determined reserves to a foreign economy.

3. A system of claim 1, wherein the one or more servers are further configured to:
determine amount of money deletion for the banking construct according to the simulated optimization scenario.

4. A system of claim 1, wherein the one or more servers are further configured to:
set, via a graphical user interface, the one or more business rules, wherein the one or more business rules specifies a threshold on consumer spending, business investment, government spending, net export, money supply, or a combination thereof,
wherein the simulated optimization scenario specifies a decrease of the money supply and an increase of the consumer spending.

5. A system of claim 1, wherein the one or more servers are further configured to:
receive, via a graphical user interface, country information, wherein the simulated optimization scenario is based on the country information.

6. A system of claim 1, wherein the simulated optimization scenario relates to either gross domestic product (GDP) or gross national product (GNP), and the one or more business rules permit one of the plurality of service agent banks to participate in banking activities without a deposit requirement.

7. A system of claim 1, wherein the economic data relates to gross domestic product information, gross national product information, global productive capacity information, inflationary information, labor information, labor effectiveness information, or a combination thereof.

8. An apparatus comprising:
at least one processor; and
at least one memory including computer program code for one or more programs, the at least one memory and the computer program code configured to, with the at least one processor, cause the apparatus to perform at least the following:
collect economic data from one or more financial systems;
retrieve identification information for a central bank and a plurality of service agent banks;
designate, using the retrieved information, the central bank and the plurality of service agent banks as part of a banking construct;
simulate an optimization scenario based on the collected economic data, the banking construct, and one or more business rules;
output the simulated optimization scenario; and
determine banking reserves for the banking construct based on the simulated optimization scenario.

9. An apparatus of claim 8, wherein the apparatus is further caused to perform at least the following:
direct the determined reserves to one or more economic sectors relating to goods and/or services,
wherein the simulated optimization scenario specifies distribution of a portion of the determined reserves to a foreign economy.

10. An apparatus of claim 8, wherein the apparatus is further caused to perform at least the following:
determine amount of money deletion for the banking construct according to the simulated optimization scenario.

11. An apparatus of claim 8, wherein the apparatus is further caused to perform at least the following:
set, via a graphical user interface, the one or more business rules, wherein the one or more business rules specifies a threshold on consumer spending, business investment, government spending, net export, money supply, or a combination thereof,
wherein the simulated optimization scenario specifies a decrease of the money supply and an increase of the consumer spending.

12. An apparatus of claim 8, wherein the apparatus is further caused to perform at least the following:
receive, via a graphical user interface, country information, wherein the simulated optimization scenario is based on the country information.

13. An apparatus of claim 8, wherein the simulated optimization scenario relates to either gross domestic product (GDP) or gross national product (GNP), and the one or more business rules permit one of the plurality of service agent banks to participate in banking activities without a deposit requirement.

14. An apparatus of claim 8, wherein the economic data relates to gross domestic product information, gross national product information, global productive capacity information, inflationary information, labor information, labor effectiveness information, or a combination thereof.

15. A method, executed on a computerized platform for determining volume of banking reserves, comprising:
collecting economic data from one or more financial systems, wherein the economic data relates to gross domestic product information, gross national product information, global productive capacity information, inflationary information, labor information, labor effectiveness information, or a combination thereof;
retrieving identification information for a central bank and a plurality of service agent banks;
designating, using the retrieved information, the central bank and the plurality of service agent banks as part of a banking construct;
simulating an optimization scenario based on the collected economic data, the banking construct, and one or more business rules;
outputting the simulated optimization scenario; and
determining banking reserves for the banking construct based on the simulated optimization scenario.

16. A method of claim 15, further comprising:
direct the determined reserves to one or more economic sectors relating to goods and/or services,
wherein the simulated optimization scenario specifies distribution of a portion of the determined reserves to a foreign economy.

17. A method of claim 15, further comprising:
determine amount of money deletion for the banking construct according to the simulated optimization scenario.

18. A method of claim 15, further comprising:
set, via a graphical user interface, the one or more business rules, wherein the one or more business rules specifies a threshold on consumer spending, business investment, government spending, net export, money supply, or a combination thereof,
wherein the simulated optimization scenario specifies a decrease of the money supply and an increase of the consumer spending.

19. A method of claim 15, further comprising:
receive, via a graphical user interface, country information, wherein the simulated optimization scenario is based on the country information.

20. A method of claim 15, wherein the simulated optimization scenario relates to either gross domestic product (GDP) or gross national product (GNP), and the one or more business rules permit one of the plurality of service agent banks to participate in banking activities without a deposit requirement.
